(19) United States
(12) Patent Application Publication
(10) Pub. No.: US 2026/0203056 A1
(43) Pub. Date: Jul. 16, 2026

(54) MODEL CASCADE FOR EFFICIENT RULE EXTRACTION

(71) Applicant: Fiserv, Inc., Milwaukee, WI (US)

(72) Inventors: Alexander Michael Whitacre, Chamblee, GA (US); Matthew Rotundo, Morristown, NJ (US); Randall Sloan Poe, JR., Black Mountain, NC (US); Sosh Howell, Asheville, NC (US)

(73) Assignee: Fiserv, Inc., Milwaukee, WI (US)

(21) Appl. No.: 19/021,993

(22) Filed: Jan. 15, 2025

(51) Int. Cl. G06F 8/74; G06F 40/226

(52) U.S. Cl. CPC G06F 8/74; G06F 40/226

(57) ABSTRACT

A method including determining whether to use a functional processing model or a machine-learning processing model and executing the functional processing model or the machine-learning processing model using as input the first input document to transform data in a first input document into the target data format, executing an extraction model using as input the data in the first input document in the target data format to generate first structured data, executing a compilation model using as input a plurality of structured data generated based on data in a set of input documents including the first input document to generate an aggregate structured data, and executing a synthesis model using as input the aggregate structured data and the plurality of structured data to generate an output data structure.

### BACKGROUND

Legacy codebases often lack detailed technical documentation that reflects evolution of software. Adding new code, changing old code, or implementing a legacy codebase is a difficult task, as developers must decipher the legacy codebase to determine its structure and various functions to effectively interact with the legacy codebase.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the disclosure are directed to a method for automatically generating computer-readable data structures based on input documents, the method including obtaining a set of input documents, for a first input document in the set of input documents, determining whether to use a functional processing model or a machine-learning processing model to transform data in the first input document into a target data format, wherein the functional processing model uses less computing power than the machine-learning processing model, based on the determination of whether to use the functional processing model or the machine-learning processing model, executing the functional processing model or the machine-learning processing model using as input the first input document to transform the data in the first input document into the target data format, executing an extraction model using as input the data in the first input document in the target data format to generate first structured data based on the data in the first input document, executing a compilation model using as input a plurality of structured data generated based on data in the set of input documents to generate an aggregate structured data based on the data in the set of input documents, the plurality of structured data including the first structured data, and executing a synthesis model using as input the aggregate structured data and the plurality of structured data to generate an output data structure.

In some implementations, the method includes determining whether to use a functional extraction model or a machine-learning extraction model to generate the first structured data, wherein the functional extraction model uses less computing power than the machine-learning extraction model. In some implementations, the method includes executing a reconciliation model using as input the aggregate structured data and the plurality of structured data to generate a reconciliation score. In some implementations, the method includes determining whether to use a functional reconciliation model or a machine-learning reconciliation model to generate the reconciliation score, wherein the functional reconciliation model uses less computing power than the machine-learning reconciliation model. In some implementations, the method includes determining whether to use a functional synthesis model or a machine-learning synthesis model to generate the output data structure, wherein the functional synthesis model uses less computing power than the machine-learning synthesis model. In some implementations, the method includes executing a validation model using as input the plurality of structured data to generate a validation score. In some implementations, the method includes determining whether to use a functional validation model or a machine-learning validation model to generate the validation score, wherein the functional validation model uses less computing power than the machine-learning validation model. In some implementations, the target data format includes a machine-learning compatible data format. In some implementations, the machine-learning processing model includes a generative AI processing model to transform the data in the first input document into the target data format. In some implementations, the machine-learning processing model includes a computer-vision model to generate intermediate data structures to be provided as input to the generative AI model.

Aspects of the disclosure are directed to a non-transitory, computer-readable medium including instructions which, when executed by one or more processors, cause the one or more processors to obtain a set of input documents, for a first input document in the set of input documents determine whether to use a functional processing model or a machine-learning processing model to transform data in the first input document into a target data format, wherein the functional processing model uses less computing power than the machine-learning processing model, based on the determination of whether to use the functional processing model or the machine-learning processing model, execute the functional processing model or the machine-learning processing model using as input the first input document to transform the data in the first input document into the target data format, execute an extraction model using as input the data in the first input document in the target data format to generate first structured data based on the data in the first input document, execute a compilation model using as input a plurality of structured data generated based on data in the set of input documents to generate an aggregate structured data based on the data in the set of input documents, the plurality of structured data including the first structured data, and execute a synthesis model using as input the aggregate structured data and the plurality of structured data to generate an output data structure.

In some implementations, the instructions further cause the one or more processors to determine whether to use a functional extraction model or a machine-learning extraction model to generate the first structured data, wherein the functional extraction model uses less computing power than the machine-learning extraction model. In some implementations, the instructions further cause the one or more processors to execute a reconciliation model using as input the aggregate structured data and the plurality of structured data to generate a reconciliation score. In some implementations, the instructions further cause the one or more processors to determine whether to use a functional reconciliation model or a machine-learning reconciliation model to generate the reconciliation score, wherein the functional reconciliation model uses less computing power than the machine-learning reconciliation model. In some implementations, the instructions further cause the one or more processors to determine whether to use a functional synthesis model or a machine-learning synthesis model to generate the output data structure, wherein the functional synthesis model uses less computing power than the machine-learning synthesis model. In some implementations, the instructions further cause the one or more processors to execute a validation model using as input the plurality of structured data to generate a validation score. In some implementations, the instructions further cause the one or more processors to determine whether to use a functional validation model or a machine-learning validation model to generate the validation score, wherein the functional validation model uses less computing power than the machine-learning validation model. In some implementations, the target data format includes a machine-learning compatible data format. In some implementations, the machine-learning processing model includes a generative AI processing model to transform the data in the first input document into the target data format. In some implementations, the machine-learning processing model includes a computer-vision model to generate intermediate data structures to be provided as input to the generative AI model.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is a block diagram of an example system for generation of output data structures based on input documents.

FIG. 2 is a flow chart illustrating example operations of a method for generation of output data structures based on input documents.

FIG. 3 is an example block diagram of a computing system.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to automatically extracting and synthesizing knowledge from input documents, such as legacy codebases. A cascade of models can be executed to generate output data structures based on the input documents. The output data structures can be automatically generated by the cascade of models to represent knowledge embedded in the input documents. The cascade of models can include various functional (i.e., algorithmic) and machine-learning models. The cascade of models can represent different stages in generating the output data structures based on the input documents such as processing, extraction, validation, compilation, synthesis, and reconciliation. The different stages can each be performed by a corresponding functional model and/or machine-learning model. One or more of the stages can include determining which of a functional model and a machine-learning model will be executed to perform the functionality of the stage. In an example, a processing stage for transforming data in input documents into a target data format for extraction can be performed by executing a functional processing model and/or by executing a machine-learning processing model, where the functional processing model is less resource-intensive than the machine-learning processing model. In this example, if the functional processing model is sufficient for transforming the data in the input documents into the target data format, the functional processing model is used, but otherwise the machine-learning processing model is used. By using the less-resource-intensive model when possible, the processing stage can be performed more efficiently. Similarly, other stages can be performed using a least-computationally-intensive model possible for each stage, improving a speed and efficiency of knowledge extraction and synthesis.

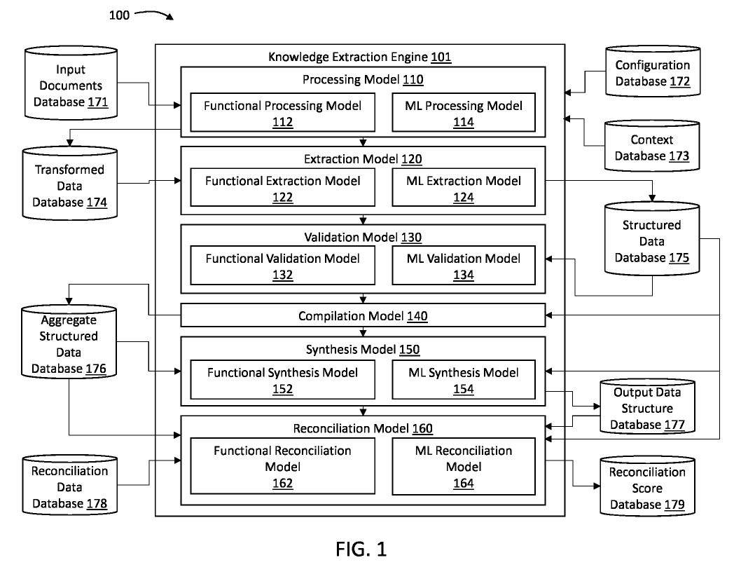

FIG. 1 is a block diagram of an example system 100 for generation of output data structures based on input documents. The system 100 includes a knowledge extraction engine 101. The knowledge extraction engine 101 receives input documents from an input documents database 171 and generates output data structures. The knowledge extraction engine 101 may extract data from the input documents and synthesize new data based on the input documents to generate the output data structure. In an example, the input documents are a legacy codebase and the knowledge extraction engine 101 generates documentation for functions, modules, and objects of the codebase as well as high-level summaries of functionality of the codebase to facilitate understanding and modification of the legacy codebase. In this example, the knowledge extraction engine 101 can generate test scenarios and unit testing code for the legacy codebase. In an example, the input documents are requirements documents and/or summary documents for a data platform or data warehouse and the knowledge extraction engine 101 extracts database structures in a scheme that aligns to a target data cataloging tool to generate a data dictionary. In an example, the input documents are contracts including various service level agreement (SLA) constraints and the knowledge extraction engine 101 generates a summary of SLAs and their characteristics. In this example, the summary of the SLAs captures how the contracts interact to define the SLA and how the SLA is measured. In an example, the input documents are contracts including billing details and the knowledge extraction engine 101 determines what products are billed for, what amounts they are billed for, and how payment is processed. In this example, the knowledge extraction engine 101 can compare incoming invoices to the extracted knowledge to determine whether the incoming invoices are valid.

The system 100 includes an input documents database 171, a configuration database 172, a context database 173, a transformed data database 174, a structured data database 175, an aggregate structured data database 176, an output data structure database 177, a reconciliation data database 178, and a reconciliation score database 179, referred to herein collectively as databases 170. In some implementations, the databases 170 are a single database. In some implementations, two or more of the databases 170 are a single database. In some implementations, two or more of the databases 170 reside in a same memory device and/or within a single computing device. In an example, the databases 170 represent logical entities within computer storage.

The knowledge extraction engine 101 includes various functional models and machine-learning models that can be executed to perform various functions within the process of extracting and synthesizing knowledge from the input documents. A functional model can refer to an algorithm including steps that are human-readable and/or human-coded. A functional model can refer to a model where each intermediate step or action performed by the model is known or readily discernible. A functional model can refer to a model that does not include any machine-learning aspects, such as a neural network. A machine-learning model can refer to a model including machine-learning aspects or trained components such as a neural network, a support vector machine, a weighted decision tree, an ensemble tree, and other machine-learning components. A machine-learning model can refer to a model where one or more intermediate steps or actions performed by the model are not known or are not readily discernible (e.g., “black box”). A machine-learning model can refer to a model where one or more components or parameters of the model were trained, and not defined by human input.

The knowledge extraction engine 101 includes a processing model 110. The processing model 110 transforms data in the input documents into a target data format. In some implementations, the target data format is a machine-readable format. In some implementations, the target data format is a format for input to a machine-learning model. In an example, the target data format is a markdown file and the processing model 110 converts formatted text in a PDF into a markdown file. In this example, the markdown file may be an expected data format for downstream machine-learning models. The processing model 110 includes a functional processing model 112 and a machine-learning processing model 114.

The functional processing model 112 can include one or more algorithms for processing the input documents to put data in the input documents in the target data format. In some implementations, the functional processing model 112 extracts text from input documents that are in a text-compatible format and outputs the text in the input documents. In an example, the functional processing model 112 extracts text in various formats in the input documents and outputs plain text. In some implementations, the functional processing model 112 algorithmically extracts text and formatting details from the input documents and puts the text and formatting details in the target data format. In an example, the functional processing model 112 algorithmically extracts text and formatting details from a PDF document and generates a markdown file including the text and formatting details from the PDF document.

The machine-learning processing model 114 can perform one or more machine-learning processes to process the input documents to put data in the input documents in the target data format. In some implementations, the machine-learning processing model 114 includes an optical character recognition (OCR) model to extract text from the input documents. In an example, the machine-learning processing model 114 performs OCR on images or scanned documents to output plain text. In some implementations, the machine-learning processing model 114 includes a generative AI model (e.g., large language model) to generate output in the target data format based on the data in the input documents. In some implementations, the machine-learning processing model 114 includes a computer vision (CV) model to decompose documents into intermediate artifacts that are provided as input to the generative AI model. In an example, the machine-learning processing model 114 uses the CV model to identify text and formatting of a PDF document, which text and formatting are provided as input to the generative AI model to generate a markdown file reflecting the content of the PDF document. In an example, the machine-learning processing model 114 uses the CV model to identify sections of a PDF document to generate a markdown file including text of the PDF document organized according to the identified sections, which markdown file is provided as input to the generative AI model. In an example, the machine-learning processing model 114 uses the CV model to identify objects in images of a PDF document to generate plain text describing the images, which plain text is provided as input to the generative AI model.

The processing model 110 determines whether to use the functional processing model 112 and/or the machine-learning processing model 114. The processing model 110 can determine whether to use the functional processing model 112 and/or the machine-learning processing model 114 for each input document, section of each input document (e.g., page), or set of input documents. The processing model 110 determines whether the functional processing model 112 can successfully transform the data in an input document into the target data format. In some implementations, the processing model 110 determines whether the functional processing model 112 can successfully transform the data in the input document based on a format and/or type of the input document. In some implementations, the processing model 110 determines whether the functional processing model 112 can successfully transform the data in the input document by attempting to use the functional processing model 112 to transform the data in the input document into the target data format. The processing model 110 can determine to use the functional processing model 112 based on the functional processing model 112 being less computationally expensive, or using less computing power or computing resources than the machine-learning processing model 114. The processing model 110 can determine to use the machine-learning processing model 114 based on the functional processing model 112 being unable to transform the data of the input document, or unable to transform the data of the input document with a threshold level of accuracy.

The processing model 110 stores the data of the input documents in the target data format in the transformed data database 174. An extraction model 120 of the knowledge extraction engine 101 retrieves the data of the input documents in the target data format from the transformed data database 174.

The extraction model 120 extracts data points from the data of the input documents (in the target data format). The extraction model 120 generates structured data including the extracted data points. In an example, the extraction model 120 generates a JSON file including the extracted data points. In an example, the input documents are a legacy codebase and the extraction model 120 extracts a list of functions. In an example, the input documents are a data warehouse and the extraction model 120 extracts partitions of the data warehouse. In an example, the input documents are a set of contracts, and the extraction model 120 extracts a list of billing items. In an example, the input documents are a set of contracts including SLA agreements and the extraction model 120 generates a description of SLA parameters. The extraction model 120 includes a functional extraction model 122 and a machine-learning extraction model 124.

The functional extraction model 122 can include one or more algorithms for extracting the data points from the input documents. In some implementations, the functional extraction model 122 extracts data points based on a format of data in the input documents. In an example, the functional extraction model 122 extracts data points based on numerical values being adjacent key words. In an example, the functional extraction model 122 extracts data points based on numerical values being found in a table.

The machine-learning extraction model 124 can perform one or more machine-learning processes to extract the data points from the input documents. In some implementations, the machine-learning extraction model 124 includes an LLM to extract data points from the input documents. In an example, the machine-learning extraction model 124 receives as input a markdown file including the data in an input document and outputs a JSON file including key points from the data in the input document. In an example, the machine-learning extraction model 124 receives as input a markdown file including code from a legacy codebase and outputs a JSON file including a description of a function included in the code.

The extraction model 120 determines whether to use the functional extraction model 122 and/or the machine-learning extraction model 124. The extraction model 120 can determine whether to use the functional extraction model 122 and/or the machine-learning extraction model 124 for each input document, section of each input document (e.g., page), or set of input documents. The extraction model 120 determines whether the functional extraction model 122 can successfully extract the data points for generation of the structured data. In some implementations, the extraction model 120 determines whether the functional extraction model 122 can successfully extract the data points for generation of the structured data based on a type and/or content of the input document. In some implementations, the extraction model 120 determines whether the functional extraction model 122 can successfully extract the data points for generation of the structured data by attempting to use the functional extraction model 122 to extract the data points for generation of the structured data. The extraction model 120 can determine to use the functional extraction model 122 based on the functional extraction model 122 being less computationally expensive, or using less computing power or computing resources than the machine-learning extraction model 124. The extraction model 120 can determine to use the machine-learning extraction model 124 based on the functional extraction model 122 being unable to extract the data points for generation of the structured data, or unable to extract the data points for generation of the structured data with a threshold level of accuracy.

The extraction model 120 stores the structured data (e.g., JSON file) in the structured data database 175. A validation model 130 of the knowledge extraction engine 101 retrieves the structured data from the structured data database 175.

The validation model 130 validates the extracted data points from the extraction model 120. The validation model 130 determines whether to use the extracted data points, generate an alert, and/or trigger a re-extraction. In an example, the validation model 130 generates an alert that one or more data points are not valid. In an example, the validation model 130 indicates to the extraction model 120 to again extract data points. In this example, the extraction model 120 can use the machine-learning extraction model 124 to implement a computationally more intense, but more accurate model to extract data points in response to an indication to again extract data points. In an example, the input documents are a legacy codebase and the validation model 130 validates whether an extracted list of functions includes valid functions for a programming language. In an example, the input documents are a data warehouse and the validation model 130 validates whether extracted partitions of the data warehouse match a functionality of the data warehouse. In an example, the input documents are a set of contracts, and the validation model 130 validates whether an extracted list of billing items includes valid products or services. In an example, the input documents are a set of contracts including SLA agreements and the validation model 130 validates whether an extracted list of SLA parameters correspond to actual SLA parameters. The validation model 130 includes a functional validation model 132 and a machine-learning validation model 134.

The functional validation model 132 can include one or more algorithms for validating the extracted data points. In some implementations, the functional validation model 132 compares extracted data points to predetermined ranges of values. In an example, the functional validation model 132 validates data points based on predetermined ranges for each type of data point. In an example, the functional validation model 132 validates a billing item based on a cost of the billing item being within a predetermined range for billing items of its type. The predetermined ranges of values can be stored in the context database 173. The context database 173 can store contextual data related to the input documents including the predetermined ranges of values. In some implementations, the functional validation model 132 determines whether expected values are present. In an example, if a cost of a billing item is missing, the functional validation model 132 determines that the data point is invalid.

The functional validation model 132 can retrieve contextual and/or conditional validation information from the context database 173. The contextual and/or conditional validation information form the context database 173 can define rules for validating the data points. The contextual validation information can include data related to types of documents and expected data points. In an example, the contextual validation information can indicate that the validation model 130 should determine whether an input document should include both shipping fees and digital download fees. In an example, the conditional validation information can indicate that the validation model 130 should determine that a data point is invalid if an input document corresponding to a digital product includes shipping fees. In an example, the contextual validation information can indicate that the validation model 130 should determine whether code includes C++ functions or python functions. In an example, the conditional validation information can indicate that a data point for a function is invalid if it does not include proper syntax.

The machine-learning validation model 134 can perform one or more machine-learning processes to validate the extracted data points. In some implementations, the machine-learning validation model 134 includes an LLM to validate the extracted data points. In an example, the LLM receives as input contextual data from the context database 173 and the extracted data points to extract validation data from the contextual data and generate a validation determination for the extracted data points using the extracted validation data. In this example, the extracted validation data can include contextual and/or conditional validation information. In this way, the LLM can extract validation instructions or rules from the contextual data. In some implementations, the machine-learning validation model 134 receives as input the extracted data points and the data from the input document (in its original format or the target data format) to compare the extracted data points to the original data in order to validate the extracted data points. In an example, the machine-learning validation model 134 receives as input a JSON file for an input document including the extracted data points as well as plain text from the input document to validate the extracted data points. In an example, the machine-learning validation model 134 receives as input a JSON file for an input document including the extracted data points as well as a PDF of the input document to validate the extracted data points. In this example, the LLM can extract information from images in the input document to validate the extracted data points.

In some implementations, the context database 173 includes a vector database including contextual data for the input documents in the input documents database 171 and the machine-learning validation model 134 performs retrieval-augmented generation (RAG) to validate the extracted data points. In an example, the machine-learning validation model 134 generates an embedding using the extracted data points, queries the vector database using the embedding for contextual data, and uses the contextual data to determine whether the extracted data points are valid.

The validation model 130 determines whether to use the functional validation model 132 and/or the machine-learning validation model 134. The validation model 130 can determine whether to use the functional validation model 132 and/or the machine-learning validation model 134 for each data point, and/or a set of data points. The validation model 130 determines whether the functional validation model 132 can successfully validate the extracted data points. In some implementations, the validation model 130 determines whether the functional validation model 132 can successfully validate the extracted data points based on a type and/or content of the input document. In some implementations, the validation model 130 determines whether the functional validation model 132 can successfully validate the extracted data points by attempting to use the functional validation model 132 to validate the extracted data points. The validation model 130 can determine to use the functional validation model 132 based on the functional validation model 132 being less computationally expensive, or using less computing power or computing resources than the machine-learning validation model 134. The validation model 130 can determine to use the machine-learning validation model 134 based on the functional validation model 132 being unable to validate the extracted data points, or unable to validate the extracted data points with a threshold level of accuracy. In some implementations, the validation model 130 can be skipped. In an example, if there is a high level of confidence in the extracted data points (e.g., based on historical performance of the extraction model 120), the validation model 130 can be bypassed to save time and computing resources.

The knowledge extraction engine 101 includes a compilation model 140. The compilation model 140 compiles validated extracted data points from a plurality of structed data for a plurality of input documents to generate aggregate structured data. The aggregate structured data can reflect extracted data points from a plurality of input documents. The aggregate structured data can include the validated extracted data points and/or additional data points generated based on the validated extracted data points. In an example, the aggregate structured data is a JSON file. In an example, the aggregate structured data can include totals for all billing items across a set of input documents. In an example, the aggregate structure data include interactions between functions across a set of code documents for a legacy codebase. In an example, the aggregate structure data include a summary of types of data in a data warehouse. The compilation model 140 can include functional and/or machine-learning elements for aggregating the data points and/or generating additional data to generate the aggregate structured data. The compilation model 140 stores the aggregate structured data in the aggregate structured data database 176.

A synthesis model 150 of the knowledge extraction engine 101 retrieves the aggregate structured data from the aggregate structured data database 176 and the structured data from the structured data database 175.

The synthesis model 150 generates output data structures based on the aggregate structured data and the structured data. In some implementations, the synthesis model 150 generates the output data structures based on the aggregate structured data and the structured data used to generate the aggregate structured data. In this way, the synthesis model 150 takes into account the data points for each input document as well as the higher-level data points in the aggregate structured data. The output data structures can include a CSV file, a text file, or any other kind of data structure. The output data structures can summarize, explain, or otherwise provide insight into the input documents. In an example, the input documents are a legacy codebase and the synthesis model 150 generates documentation for the legacy codebase. In an example, the input documents are a data warehouse and the synthesis model 150 generates a summary of the structure and types of data of the data warehouse. In an example, the input documents are a set of contracts, and the synthesis model 150 generates a report detailing billing amounts and billing trends. In an example, the input documents are a set of contracts including SLA agreements and the synthesis model 150 generates a summary explanation of an SLA and parameters of the SLA. The synthesis model 150 includes a functional synthesis model 152 and a machine-learning synthesis model 154.

The functional synthesis model 152 can include one or more algorithms for generating the output data structure. In some implementations, the functional synthesis model 152 places values from the extracted data points within a table, where the aggregate data structure informs a title for the table. In an example, the functional synthesis model 152 places values from the extracted data points within a CSV file, where the aggregate data structure informs how the values are placed within the CSV file. In an example, the functional synthesis model 152 generates a table summarizing billing totals for different products, where the totals are reflected in an aggregate data structure based on individual billing items in structured data generated by the extraction model 120. In an example, the functional synthesis model 152 generates a summary of functions included in a legacy codebase based on an aggregate structured data that includes names of functions from structured data. In some implementations, the synthesis model 150 retrieves data from the context database 173 to generate the output data structure. In an example, the context database 173 includes a template for the output data structure.

The machine-learning synthesis model 154 can perform one or more machine-learning processes to generate the output data structure. In some implementations, the machine-learning synthesis model 154 includes an LLM to generate the output data structure. In an example, the LLM receives as input a set of structured data and an aggregate structured data corresponding to the set of structured data to generate the output data structure. In this example, the LLM can also receive as input the contextual data from the context database 173. In some implementations, the machine-learning synthesis model 154 receives as input the set of structured data, the aggregate structured data, and the input documents to generate the output data structure.

In some implementations, the context database 173 includes a vector database including contextual data for the input documents in the input documents database 171 and the machine-learning synthesis model 154 performs retrieval-augmented generation (RAG) to generate the output data structure. In an example, the machine-learning synthesis model 154 generates an embedding using the set of structured data and/or the aggregate structured data, queries the vector database using the embedding for contextual data, and uses the contextual data to generate the output data structure.

The synthesis model 150 determines whether to use the functional synthesis model 152 and/or the machine-learning synthesis model 154. The synthesis model 150 can determine whether to use the functional synthesis model 152 and/or the machine-learning synthesis model 154 for each aggregate structured data. The synthesis model 150 determines whether the functional synthesis model 152 can successfully generate the output data structure. In some implementations, the synthesis model 150 determines whether the functional synthesis model 152 can successfully generate the output data structure based on a type and/or content of the aggregate structured data. In some implementations, the synthesis model 150 determines whether the functional synthesis model 152 can successfully generate the output data structure by attempting to use the functional synthesis model 152 to generate the output data structure. The synthesis model 150 can determine to use the functional synthesis model 152 based on the functional synthesis model 152 being less computationally expensive, or using less computing power or computing resources than the machine-learning synthesis model 154. The synthesis model 150 can determine to use the machine-learning synthesis model 154 based on the functional synthesis model 152 being unable to generate the output data structure, or unable to generate the output data structure with a threshold level of accuracy.

In some implementations, the knowledge extraction engine 101 includes a reconciliation model 160. The reconciliation model 160 reconciles the set of structured data and the aggregate structured data and/or the output data structure with reconciliation data from the reconciliation data database 178 to generate a reconciliation score. In some implementations, the reconciliation data includes systems of record corresponding to the input documents. The reconciliation model 160 determines whether to use the output data structure, generate an alert, and/or trigger a re-synthesis of the output data structure. In an example, the reconciliation model 160 generates an alert that the aggregate structured data includes one or more data points that cannot be reconciled (e.g., do not match) with a data point in the reconciliation data database 178. In an example, the input documents are a legacy codebase and the reconciliation model 160 determines whether a summary of functions in the legacy codebase matches a pre-existing summary of the functions. In an example, the input documents are a data warehouse and the reconciliation model 160 determines whether a summary of a structure of the data warehouse in an aggregate structured data matches a pre-existing summary. In an example, the input documents are a set of contracts, and the reconciliation model 160 determines whether total billing amount for a set of products in an aggregate structured data matches an entry from an accounting ledger for the set of products. In an example, the input documents are a set of contracts including SLA agreements and the reconciliation model 160 determines whether a recovery time objective (RTO) of an SLA matches a stored indication of the RTO. The reconciliation model 160 includes a functional reconciliation model 162 and a machine-learning reconciliation model 164.

The functional reconciliation model 162 can include one or more algorithms for reconciling the aggregate structured data and/or the output data structure with the reconciliation data. In some implementations, the functional reconciliation model 162 compares data points in the aggregate structured data to data points in the reconciliation data, or to predefined ranges of values in the reconciliation data.

The machine-learning reconciliation model 164 can perform one or more machine-learning processes to reconcile the aggregate structured data and/or the output data structure with the reconciliation data. In some implementations, the machine-learning reconciliation model 164 includes an LLM to aggregate structured data and/or the output data structure with the reconciliation data. In an example, the LLM receives as input the aggregate structured data, the set of structured data, and the reconciliation data to generate a reconciliation determination.

The reconciliation model 160 determines whether to use the functional reconciliation model 162 and/or the machine-learning reconciliation model 164. The reconciliation model 160 can determine whether to use the functional reconciliation model 162 and/or the machine-learning reconciliation model 164 for each aggregate structured data. The reconciliation model 160 determines whether the functional reconciliation model 162 can successfully reconcile the aggregate structured data and/or the output data structure with the reconciliation data. In some implementations, the reconciliation model 160 determines whether the functional reconciliation model 162 can successfully reconcile the aggregate structured data and/or the output data structure with the reconciliation data based on a type and/or content of the aggregate data structure. In some implementations, the reconciliation model 160 determines whether the functional reconciliation model 162 can successfully reconcile the aggregate structured data and/or the output data structure with the reconciliation data by attempting to use the functional reconciliation model 162 to reconcile the aggregate structured data and/or the output data structure with the reconciliation data. The reconciliation model 160 can determine to use the functional reconciliation model 162 based on the functional reconciliation model 162 being less computationally expensive, or using less computing power or computing resources than the machine-learning reconciliation model 164. The reconciliation model 160 can determine to use the machine-learning reconciliation model 164 based on the functional reconciliation model 162 being unable to reconcile the aggregate structured data and/or the output data structure with the reconciliation data, or unable to reconcile the aggregate structured data and/or the output data structure with the reconciliation data with a threshold level of accuracy. In some implementations, the reconciliation model 160 can be skipped. In an example, if there is a high level of confidence in the output data structure (e.g., based on historical performance of the synthesis model 150), the reconciliation model 160 can be bypassed to save time and computing resources.

The reconciliation model 160 stores the reconciliation scores in the reconciliation score database 179. In some implementations, the knowledge extraction engine 101 is used to determine an action to be performed with the output data structure. In an example, the knowledge extraction engine 101 generates an alert for a human operator to compare the output data structure to the reconciliation data based on the reconciliation score. In an example, the knowledge extraction engine 101 determines whether to transmit the output data structure to a computing system based on the reconciliation score. In an example, the knowledge extraction engine 101 determines whether to update a database of the databases 170 using the output data structure based on the reconciliation score. In this example, the output data structure can be added to the context database 173.

The configuration database 172 can include a configuration for execution of the processing model 110, the extraction model 120, the validation model 130, the compilation model 140, the synthesis model 150, and/or the reconciliation model 160. In some implementations, the configuration includes threshold accuracies to trigger execution of machine-learning models instead of functional models. In some implementations, the configuration includes a preference for either a machine-learning model or a functional model within a particular model. In some implementations, the configuration includes a preference for a particular process to be followed by one or more of the models.

The processing model 110, the extraction model 120, the validation model 130, the compilation model 140, the synthesis model 150, and/or the reconciliation model 160 can be updated based on feedback. In an example, the reconciliation score can be used to update the processing model 110, the extraction model 120, the validation model 130, the compilation model 140, and/or the synthesis model 150 (i.e., the machine-learning models). In an example, feedback from the validation model 130 (i.e., validation scores) can be used to update the extraction model 120 and/or the processing model 110.

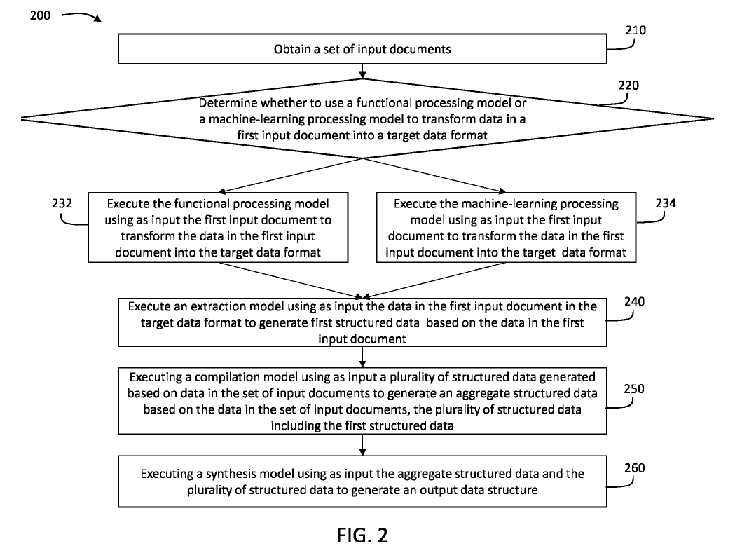

FIG. 2 is a flow chart illustrating example operations of a method 200 for generation of output data structures based on input documents. The method 200 may include more, fewer, or different operations than shown. The operations can be performed in the order shown, in a different order, or concurrently. The method 200 can be performed by the knowledge extraction engine 101 of FIG. 1.

At operation 210, a set of input documents is obtained. The set of input documents can include any number of documents. The set of input documents can be related as part of a corpus of documents. In an example, the set of input documents are code of a legacy codebase. In an example, the set of input documents are database structures of a data warehouse. In an example, the set of input documents are contracts for a business.

At operation 220, it is determined whether to use a functional processing model or a machine-learning processing model to transform data in a first input document of the set of documents into a target data format. The functional processing model may use less computing power or fewer computing resources than the machine-learning processing model, making execution of the functional processing model preferable if a threshold accuracy is maintained. In some implementations, determining whether to execute the functional processing model includes executing the functional processing model to determine whether the first structured data meets a predefined threshold accuracy. In some implementations, the target data format is a machine-learning compatible data format, or a data format that is compatible for use as input to downstream machine-learning models.

At operation 232, in response to determining to use the functional processing model, the functional processing model is executed using as input the first input document to transform the data in the first input document into the target data format.

At operation 234, in response to determining to use the machine-learning processing model, the machine-learning processing model is executed using as input the first input document to transform the data in the first input document into the target data format. In some implementations, the machine-learning processing model includes a generative AI processing model to transform the data in the first input document into the target data format. In some implementations, the machine-learning processing model includes a computer-vision model to generate intermediate data structures to be provided as input to the generative AI model. In an example, the computer-vision model generates a markdown file based on tables, graphics, and/or text in the input document and the generative AI model is executed using as input the markdown file to transform the data into the target data format.

At operation 240, an extraction model is executed using as input the data in the first input document in the target data format to generate first structured data based on the data in the first input document. In some implementations, the method 200 includes determining whether to use a functional extraction model or a machine-learning extraction model to generate the first structured data. The functional extraction model may use less computing power or fewer computing resources than the machine-learning extraction model, making execution of the functional extraction model preferable if a threshold accuracy is maintained. In some implementations, determining whether to execute the functional extraction model includes executing the functional extraction model to determine whether the first structured data meets a predefined threshold accuracy.

In some implementations, the method 200 includes executing a validation model using as input the plurality of structured data to generate a validation score. In some implementations, the method includes triggering re-processing or re-extraction based on the validation score. The validation score can be generated based on a comparison of the plurality of structured data with expected formats, predetermined ranges of values, and/or a content of the input documents. In some implementations, the method 200 includes determining whether to use a functional validation model or a machine-learning validation model. As discussed herein, the functional validation model can use less computing power than the machine-learning validation model.

At operation 250, a compilation model is executed using as input a plurality of structured data (including the first structured data) each generated based on data in the set of input documents to generate an aggregate structured data based on the data in the set of input documents. In some implementations, each structured data corresponds to an input document of the set of input documents, and the aggregate structured data corresponds to a set of structured data that are logically connected (e.g., based on a content of the corresponding input documents).

At operation 260, a synthesis model is executed using as input the aggregate structured data and the plurality of structured data to generate an output data structure. In some implementations, the method 200 includes determining whether to use a functional synthesis model or a machine-learning synthesis model to generate the output data structure. As discussed herein, the functional synthesis model can use less computing power than the machine-learning synthesis model.

In some implementations, the method 200 includes executing a reconciliation model using as input the aggregate structured data and the plurality of structured data to generate a reconciliation score. In some implementations, the reconciliation model is executed using the aggregate structured data, the plurality of structured data, and existing data to reconcile the aggregate structured data and/or the plurality of structured data with the existing data to determine whether the aggregate structured data and/or the plurality of structured data match the existing data. In some implementations, the method 200 includes determining whether to use a functional reconciliation model or a machine-learning reconciliation model to generate the reconciliation score. As discussed herein, the functional reconciliation model can use less computing power than the machine-learning reconciliation model.

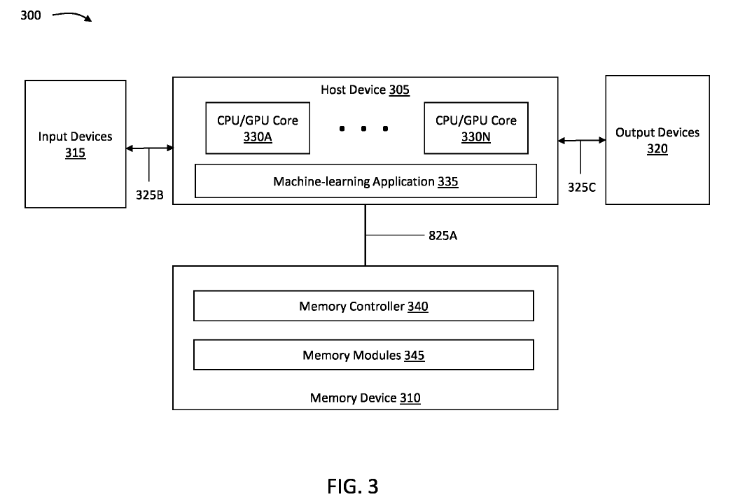

FIG. 3 is an example block diagram of a computing system 300, in accordance with some embodiments of the present disclosure. The computing system 300 includes a host device 305 associated with a memory device 310. The host device 305 may be configured to receive input from one or more input devices 315 and provide output to one or more output devices 320. The host device 305 may be configured to communicate with the memory device 310, the input devices 315, and the output devices 320 via appropriate interfaces or channels 325A, 325B, and 325C, respectively. The computing system 300 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 305.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 300) may be implemented by multiple computing devices in a distributed environment, and vice versa.

The input devices 315 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 305 and that allows an external source, such as a user, computer, or database, to enter information (e.g., data) into the host device and send instructions to the host device 305. Similarly, the output devices 320 may include a variety of output technologies such as external memories, databases, printers, speakers, displays, microphones, light emitting diodes, headphones, plotters, speech generating devices, video devices, and any other output peripherals that are configured to receive information (e.g., data) from the host device 305. The “data” that is either input into the host device 305 and/or output from the host device may include any of a variety of textual data, graphical data, video data, sound data, position data, combinations thereof, or other types of analog and/or digital data that is suitable for processing using the computing system 300.

The host device 305 may include one or more Central Processing Unit (“CPU”) or Graphics Processing Unit (“GPU”) cores or processors 330A-330N that may be configured to execute instructions for running one or more applications associated with the host device 305. In some embodiments, the instructions and data needed to run the one or more applications may be stored within the memory device 310. The host device 305 may also be configured to store the results of running the one or more applications within the memory device 310. One such application on the host device 305 may include a rule extraction and synthesis application 335. The rule extraction and synthesis application 335 may be executed by one or more of the CPU/GPU cores 330A-330N. The instructions to execute the rule extraction and synthesis application 335 may be stored within the memory device 310. The rule extraction and synthesis application 335 is described in greater detail above and may perform functions such as the method 200 of FIG. 2. Thus, the host device 305 may be configured to request the memory device 310 to perform a variety of operations. For example, the host device 305 may request the memory device 310 to read data, write data, update or delete data, and/or perform management or other operations.

To facilitate communication with the memory device 310, the memory device 310 may include or be associated with a memory controller 340. Although the memory controller 340 is shown as being part of the memory device 310, in some embodiments, the memory controller 340 may instead be part of the host device 305 or another element of the computing system 300 and operatively associated with the memory device 310. The memory controller 340 may be configured as a logical block or circuitry that receives instructions from the host device 305 and performs operations in accordance with those instructions. For example, when the execution of the rule extraction and synthesis application 335 is desired, the host device 305 may send a request to the memory controller 340. The memory controller 340 may read the instructions associated with the rule extraction and synthesis application 335 that are stored within the memory device 310, and send those instructions back to the host device. In some embodiments, those instructions may be temporarily stored within a memory on the host device 305. One or more of the CPU/GPU cores 330A-330N may then execute those instructions by performing one or more operations called for by those instructions of the rule extraction and synthesis application 335.

The memory device 310 may include one or more memory circuits 345 that store data and instructions. The memory circuits 345 may be any of a variety of memory types, including a variety of volatile memories, non-volatile memories, or a combination thereof. For example, in some embodiments, one or more of the memory circuits 345 or portions thereof may include NAND flash memory cores. In other embodiments, one or more of the memory circuits 345 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 310. In some embodiments, one or more of the memory circuits 345 or portions thereof may be configured as other types of storage class memory (“SCM”). Generally speaking, the memory circuits 345 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 300 are shown and described in FIG. 3. However, the computing system 300 may include other components such as various batteries and power sources, networking interfaces, routers, switches, external memory systems, controllers, etc. Generally speaking, the computing system 300 may include any of a variety of hardware, software, and/or firmware components that are needed or considered desirable in performing the functions described herein. Similarly, the host device 305, the input devices 315, the output devices 320, and the memory device 310, including the memory controller 340 and the memory circuits 345, may include hardware, software, and/or firmware components that are considered necessary or desirable in performing the functions described herein. In addition, in certain embodiments, the memory device 310 may integrate some or all of the components of the host device 305, including, for example, the CPU/GPU cores 330A-330N, and the CPU/GPU cores may be configured to execute the rule extraction and synthesis application 335, as described herein.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected," or "operably coupled," to each other to achieve the desired functionality, and any two components capable of being so associated can also be viewed as being "operably couplable," to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., "a" and/or "an" should typically be interpreted to mean "at least one" or "one or more"); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, etc.). In those instances, where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B." Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for automatically generating computer-readable data structures based on input documents, the method comprising:
obtaining a set of input documents;
for a first input document in the set of input documents:
determining whether to use a functional processing model or a machine-learning processing model to transform data in the first input document into a target data format, wherein the functional processing model uses less computing power than the machine-learning processing model;
based on the determination of whether to use the functional processing model or the machine-learning processing model, executing the functional processing model or the machine-learning processing model using as input the first input document to transform the data in the first input document into the target data format;
executing an extraction model using as input the data in the first input document in the target data format to generate first structured data based on the data in the first input document;
executing a compilation model using as input a plurality of structured data generated based on data in the set of input documents to generate an aggregate structured data based on the data in the set of input documents, the plurality of structured data including the first structured data; and
executing a synthesis model using as input the aggregate structured data and the plurality of structured data to generate an output data structure.

2. The method of claim 1, further comprising determining whether to use a functional extraction model or a machine-learning extraction model to generate the first structured data, wherein the functional extraction model uses less computing power than the machine-learning extraction model.

3. The method of claim 1, further comprising executing a reconciliation model using as input the aggregate structured data and the plurality of structured data to generate a reconciliation score.

4. The method of claim 3, further comprising determining whether to use a functional reconciliation model or a machine-learning reconciliation model to generate the reconciliation score, wherein the functional reconciliation model uses less computing power than the machine-learning reconciliation model.

5. The method of claim 1, further comprising determining whether to use a functional synthesis model or a machine-learning synthesis model to generate the output data structure, wherein the functional synthesis model uses less computing power than the machine-learning synthesis model.

6. The method of claim 1, further comprising executing a validation model using as input the plurality of structured data to generate a validation score.

7. The method of claim 6, further comprising determining whether to use a functional validation model or a machine-learning validation model to generate the validation score, wherein the functional validation model uses less computing power than the machine-learning validation model.

8. The method of claim 1, wherein the target data format comprises a machine-learning compatible data format.

9. The method of claim 1, wherein the machine-learning processing model includes a generative AI processing model to transform the data in the first input document into the target data format.

10. The method of claim 1, wherein the machine-learning processing model includes a computer-vision model to generate intermediate data structures to be provided as input to the generative AI model.

11. A non-transitory, computer-readable medium including instructions which, when executed by one or more processors, cause the one or more processors to:
obtain a set of input documents;
for a first input document in the set of input documents:
determine whether to use a functional processing model or a machine-learning processing model to transform data in the first input document into a target data format, wherein the functional processing model uses less computing power than the machine-learning processing model;
based on the determination of whether to use the functional processing model or the machine-learning processing model, execute the functional processing model or the machine-learning processing model using as input the first input document to transform the data in the first input document into the target data format;
execute an extraction model using as input the data in the first input document in the target data format to generate first structured data based on the data in the first input document;
execute a compilation model using as input a plurality of structured data generated based on data in the set of input documents to generate an aggregate structured data based on the data in the set of input documents, the plurality of structured data including the first structured data; and
execute a synthesis model using as input the aggregate structured data and the plurality of structured data to generate an output data structure.

12. The non-transitory, computer-readable medium of claim 11, wherein the instructions further cause the one or more processors to determine whether to use a functional extraction model or a machine-learning extraction model to generate the first structured data, wherein the functional extraction model uses less computing power than the machine-learning extraction model.

13. The non-transitory, computer-readable medium of claim 11, wherein the instructions further cause the one or more processors to execute a reconciliation model using as input the aggregate structured data and the plurality of structured data to generate a reconciliation score.

14. The non-transitory, computer-readable medium of claim 13, wherein the instructions further cause the one or more processors to determine whether to use a functional reconciliation model or a machine-learning reconciliation model to generate the reconciliation score, wherein the functional reconciliation model uses less computing power than the machine-learning reconciliation model.

15. The non-transitory, computer-readable medium of claim 11, wherein the instructions further cause the one or more processors to determine whether to use a functional synthesis model or a machine-learning synthesis model to generate the output data structure, wherein the functional synthesis model uses less computing power than the machine-learning synthesis model.

16. The non-transitory, computer-readable medium of claim 11, wherein the instructions further cause the one or more processors to execute a validation model using as input the plurality of structured data to generate a validation score.

17. The non-transitory, computer-readable medium of claim 16, wherein the instructions further cause the one or more processors to determine whether to use a functional validation model or a machine-learning validation model to generate the validation score, wherein the functional validation model uses less computing power than the machine-learning validation model.

18. The non-transitory, computer-readable medium of claim 11, wherein the target data format comprises a machine-learning compatible data format.

19. The non-transitory, computer-readable medium of claim 11, wherein the machine-learning processing model includes a generative AI processing model to transform the data in the first input document into the target data format.

20. The non-transitory, computer-readable medium of claim 11, wherein the machine-learning processing model includes a computer-vision model to generate intermediate data structures to be provided as input to the generative AI model.
